(19) United States
(12) Patent Application Publication
(10) Pub. No.: US 2007/0072683 A1
(43) Pub. Date: Mar. 29, 2007

(54) GAMING DEVICE BUTTON

(76) Inventors: Jerald C. Seelig, Absecon, NJ (US); Lawrence M. Henshaw, Hammonton, NJ (US)

Correspondence Address: IAN F. BURNS & ASSOCIATES, P.O. BOX 71115, RENO, NV, 89570, US

(21) Appl. No.: 11/469,202

(22) Filed: Aug. 31, 2006

Related U.S. Application Data
(60) Provisional application No. 60/716,548, filed on Sep. 12, 2005.

(51) Int. Cl. G06F 19/00

(52) U.S. Cl. 463/47

(57) ABSTRACT

A gaming device button includes a housing that is partially transparent. The housing is adapted to be mounted to a gaming device. The housing has a cavity. A printed circuit board is mounted in the cavity. At least one light emitting diode is mounted to the printed circuit board. A control circuit is mounted to the printed circuit board for controlling the operation of the light emitting diode.

### FIELD OF THE INVENTION

The present invention relates to gaming devices. More specifically, the invention includes an illuminated button that can be used with existing gaming devices.

### BACKGROUND

Gaming Devices

Gaming devices are well known in the art and a large variety of gaming devices have been developed. In general, gaming devices allow users or players to play a game. In many casino-type gaming devices, the outcome of the game depends, at least in part, on a randomly generated event. For example, a gaming device may use a random number generator to generate a random or pseudo-random number. The random number may then be compared to a predefined table to determine the outcome of the event. If the random number falls within a certain range of numbers on the table, the player may win a predefined prize. The table may also contain display information that allows the gaming device to generate a display that corresponds to the outcome of the game. The gaming device may present the outcome of the game on a large variety of display devices, such as mechanical spinning reels or video screens.

Bonus Games

Some gaming devices award bonuses in addition to prizes that are awarded in the primary game. A bonus can be defined as an additional prize that is awarded to the player when a predefined event occurs. An example of a bonus game can be found in U.S. Pat. No. 5,848,932 issued to Adams. One of the gaming devices described in this document comprises three spinning reels and a spinning wheel bonus display. When predetermined indicia are displayed on the spinning reels of the primary game, the wheel can be activated to indicate a bonus prize. The bonus prize is awarded in addition to any prizes awarded in the primary game.

In another embodiment described in this document, the gaming device includes a container having one or more movable objects and a transport device for transporting the one or more movable objects within the container. When predetermined symbols are displayed on the reels of the primary game, the transport device can be activated to transport the movable objects while the player is allowed to play the bonus game.

Generally, bonus prizes are offered in such games in order to increase the excitement and enjoyment experienced by players. This attracts more players to the game and encourages players to play longer. When gaming devices attract more players and the players play longer, they tend to be more commercially successful relative to other gaming devices.

Buttons

Gaming devices use buttons or switches in order to start or stop a game or game sequence. Buttons can also be used to accept player input to control some aspect of the game or to select a particular game path or game play alternative.

A button on a gaming device needs to be attractive and visually recognizable. It is, therefore, desirable for gaming devices to incorporate highly visible buttons.

Buttons used on gaming devices of the prior art use either an unlighted switch or a lighted switch. Buttons that use a lighted switch typically contain a conventional incandescent light bulb.

Unfortunately, current buttons are limited in their capacity to operate in multiple modes or to display a variety of colors.

### SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to provide game players with a more exciting and desirable gaming experience;

the ability to attract more patrons to play a game;

provide a gaming device that utilizes a visually appealing and highly visible button;

provide a button that can display several choices or modes to a game player;

provide a button that can display several colors and flashing patterns; and

provide a control circuit that can detect when a the gaming device has entered into a different state, such as a bonus game, and change the illumination pattern of a button;

These and other advantages may be realized by reference to the remaining portions of the specification, claims, and abstract.

### Brief Description of One Embodiment of the Present Invention

In certain embodiments, the present invention relates to a button for a gaming device. The button includes a housing that is partially transparent. The housing is adapted to be mounted to the gaming device. The housing has a cavity. At least one light emitting diode is mounted in the cavity. A control circuit is mounted to the printed circuit board for controlling the operation of the light emitting diode.

In another embodiment, the present invention relates to a method of operating a button for a gaming device. The method includes providing a light emitting diode that is mounted in a partially transparent housing. A control signal is detected. The control signal is decoded to determine an operating mode for the light emitting diode. The light emitting diode is illuminated according to the operating mode.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a front view of a gaming device of one embodiment of the present invention.

FIG. 2 is substantially an enlarged exploded perspective view of a button of one embodiment of the present invention that may be used on the game device of FIG. 1.

FIG. 3A is substantially a top view of a printed circuit board used with the button of FIG. 2.

FIG. 3B is substantially a bottom view of a printed circuit board used with the button of FIG. 2.

FIGS. 4A and 4B are substantially schematic diagrams of the electrical circuit used in the present invention.

### DESCRIPTION OF CERTAIN EMBODIMENTS OF THE PRESENT INVENTION

In the following detailed description of the embodiments, reference is made to the accompanying drawings, which form a part of this application. The drawings show, by way of illustration, specific embodiments in which the invention may be practiced. It is to be understood that other embodiments may be utilized and structural changes may be made with out departing from the scope of the present invention.

In the Detailed Description below, the applicants utilize various spatially orienting terms such as “upper,” “lower,” “horizontal,” and “vertical.” It is to be understood that these terms are used for ease of description of the embodiments with respect to the drawings but are not necessarily in themselves limiting or requiring of an orientation as thereby described in the following Detailed Description.

Game Apparatus

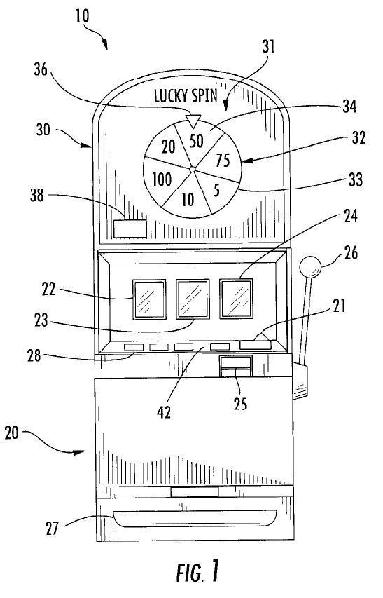

Referring to FIG. 1, one embodiment disclosed herein comprises a gaming device, generally indicated by reference number 10. Gaming device 10 comprises a primary game apparatus 20 and a bonus game apparatus 30. Bonus game 30 may comprise a display device 31. Game apparatus 20 may be any of a large number of devices that are adapted to allow players to play a game. For example, game apparatus 20 may utilize reel displays, such as spinning reels 22-24 or a video display (not shown), to display outcomes of the game. Means may also be provided for accepting wagers, such as a coin slot 21 or card reader 25, and for awarding prizes, such as a coin dispenser 27. A handle 26 and at least one button 28 are provided for activating game apparatus 20 to begin a game. Additional buttons 28 can be provided for allowing a game player to make additional selections. Game apparatus 20 can include a plate 42 for the mounting of buttons 28. Plate 42 can also serve as a hand rest for a game player. In at least one embodiment, game apparatus 20 may be an S Plus model gaming device manufactured by International Game Technology in Reno, Nev.

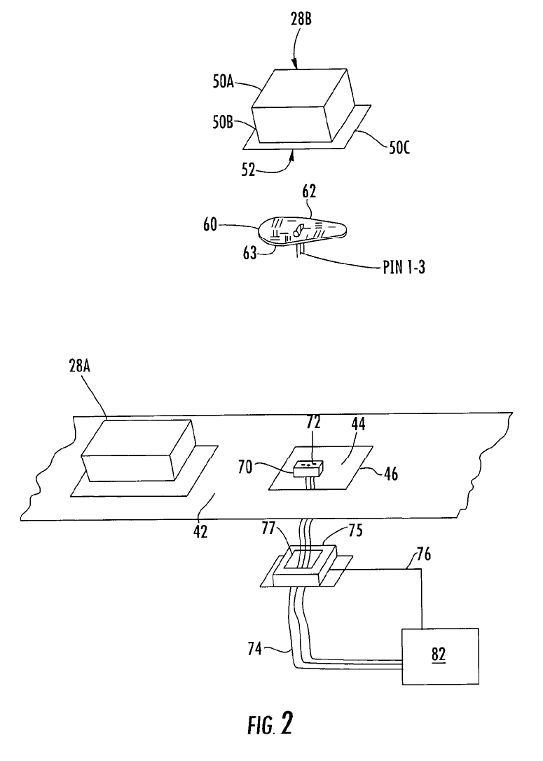

Game apparatus 20 is preferably controlled by an electronic controller 82 (see FIG. 2) that utilizes a random number generator. The random number generator produces a random or pseudo random number for each game. The outcome of the game may be determined by comparing the random number to a table of outcomes stored in a memory and accessed by controller 82. A number of different tables of outcomes may be used and different tables may be used for different games. The tables can be designed so that different prizes have different probabilities of being awarded. Such design techniques are well known in gaming. Examples of such designs are shown in U.S. Pat. No. 4,448,419, issued to Telnaes, and U.S. Pat. No. 5,456,465, issued to Durham. Controller 82 causes spinning reels 22-24 of the video display to show the outcome of the game that corresponds to the outcome of the random number generator. It is recognized that game apparatus 20 may operate in many other ways and still achieve the objects of the present invention.

Game apparatus 20 may also be capable of producing a bonus-activating event. This event may be many different types of events. For example, a bonus-activating event may comprise displaying a particular symbol, such as a “bonus” symbol, or combination of symbols, such as three “7” symbols, on reels 22-24. If the game being played is poker based, the bonus-activating event may be occurrence of a certain hand, such as a royal flush. Furthermore, a bonus-activating event may occur when a player accumulates a number of symbols or game outcomes over a number of separate game plays. For example, a bonus-activating event may occur when the player receives three “bonus” symbols during a period of time. The bonus-activating event may be based on an external event. For example, a bonus-activating event may occur when a group of players obtain a certain result. After a bonus activating event, game apparatus 20 may enter one or more bonus modes or states.

Bonus game apparatus 30 can include a prize display or wheel 32. Prize wheel 32 is divided into several segments 33. Each of the segments has an indicia 34 mounted thereon. Indicia 34 can indicate the game outcome of bonus game apparatus 30. For example, indicia 34 can indicate a winning amount such as 10 or 20 credits or can indicate a multiplier amount such as 2× or can indicate the winning of physical prizes such as a vacation or a car. Prize wheel 32 can be rotated and stopped such that pointer 36 can indicate a game outcome. Any prizes can be displayed on display 38.

Gaming Device Button

Referring to FIG. 2, an assembled view of a button 28A and an exploded view of a button 28B is shown. Button 28B has a top 50A, sides 50B and a rim 50C. Top 50B is adapted to be touched and depressed by a game player. Button 28B may have a hollow cavity 52. Button 28 can be made from a wide variety of materials such as plastic. Button 28 may be at least partially transparent such that light can be transmitted through button 28.

A printed circuit board 60 has a top side 62 and a bottom side 63. Pins 1, 2 and 3 may extend from bottom side 63. Printed circuit board 60 can be a conventional printed circuit board and includes printed circuit lines and plated through holes (not shown). Printed circuit board 60 may be mounted in cavity 52.

Plate 42 may have an aperture 44 that defines an edge 46. An electrical connector 70 may extend through aperture 44 and may be adapted to connect with pins 1-3. Connector 70 has receptacles 72 that engage pins 1-3 and a wire harness 74 that is connected with controller 82. Controller 82 is in communication with and can supply signals to button 28 through connector 70.

A switch 75 is mounted below plate 42 adjacent to aperture 44. Switch 75 can be attached to plate 42 by any conventional fastener. Switch 75 is a conventional momentary on/off switch. Switch 75 may have an aperture 77 through which wire harness 74 passes. Switch 75 is in communication with controller 82 through wire 76. Sufficient depression of the button causes switch 75 to close allowing a current to flow through switch 75.

Button 28A is shown in an assembled state. During assembly, the button is placed through aperture 44 from the under side of plate 42 such that rim 50C contacts plate 42. Printed circuit board 60 may be supported in cavity 52 by connector 70. Additional fasteners can also support circuit board 60 if desired.

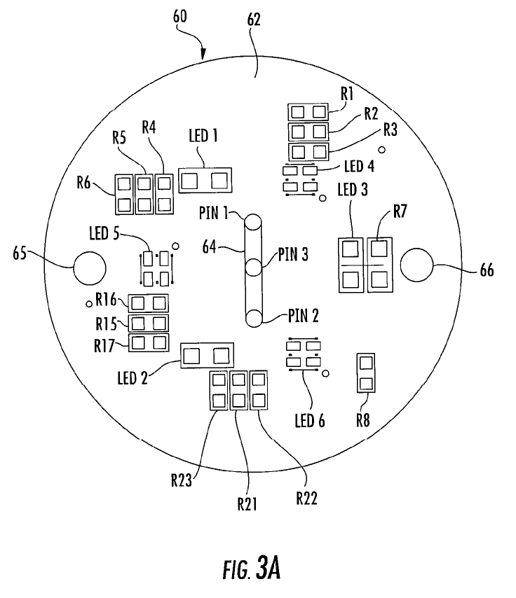

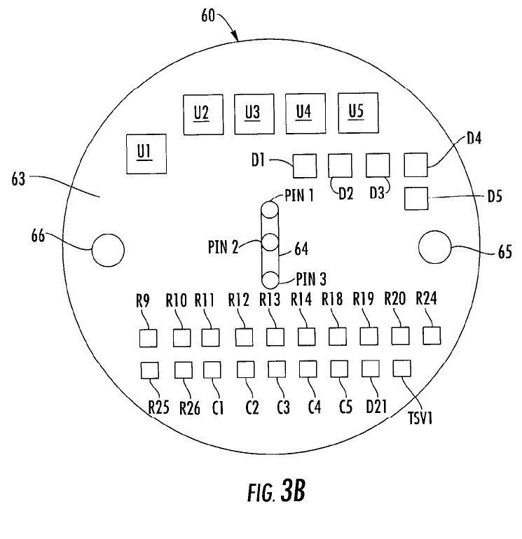

Turning now to FIG. 3A, a top side 62 of printed circuit board 60 is shown. Printed circuit board 60 may have a slot 64 and apertures 65 and 66. Pins 1-3 extend through slot 64 and would be soldered to a respective printed circuit line (not shown). Various electrical components are mounted to the side 61 using conventional electronic assembly techniques such as soldering. The components include Resistors R1, R2, R3, R4, R5, R6, R7, R8, R15, R16, R17, R21, R22 and R23, Light Emitting Diodes LED1, LED2, LED3, LED4, LED4 and LED6.

Turning now to FIG. 3B, the bottom side 63 of one embodiment of printed circuit board 60 is shown. Side 61 has components mounted thereon including Transient Voltage Suppressor TSV1, Diodes D1, D2, D3, D4, D5, Zener diode DZ1, Capacitors C1, C2, C3, C4, C5, Integrated Circuits U1, U2, U3, U4 and U5, Resistors R9, R10, R11, R12, R13, R14, R18, R19, R20, R24, R25 and R26. The components on top side 62 (see FIG. 3A) and bottom side 63 are electrically interconnected by conventional plated through holes (not shown).

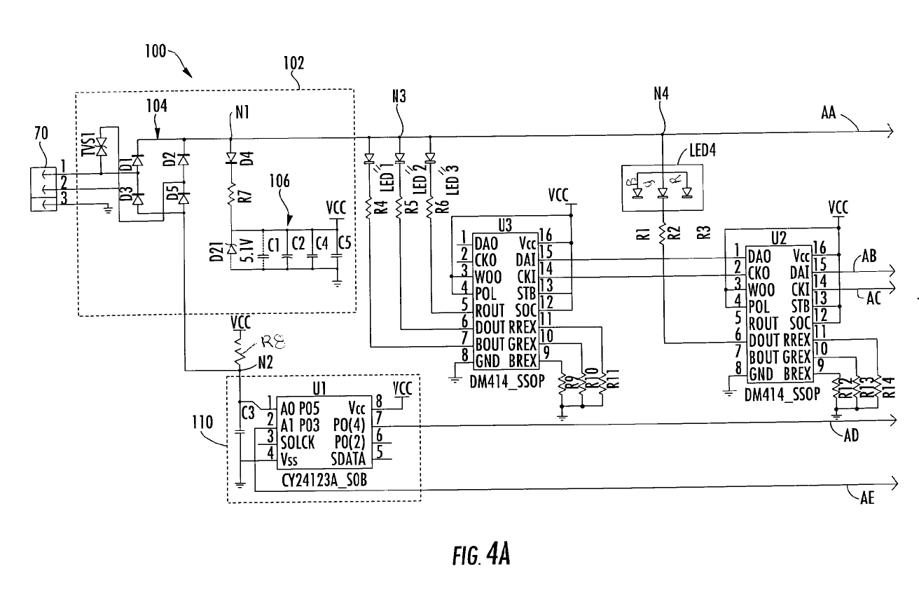

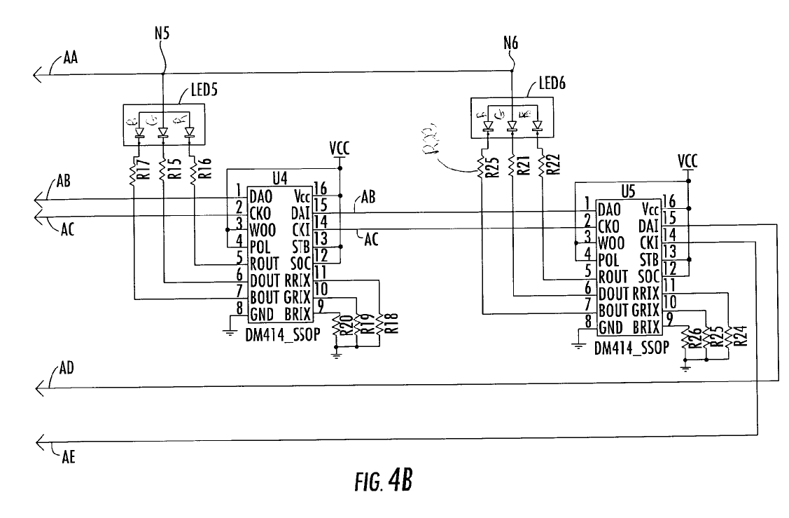

FIGS. 4A and 4B illustrate a schematic diagram of a button control circuit 100. Circuit lines AA, AB, AC, AD and AE continue from FIG. 4A to 4B. With reference to FIGS. 4A and 4B, button control circuit 100 has a power supply and conditioning circuit 104. Power supply circuit 104 is connected to an alternating 30 Hz power source through connector 70. Power supply circuit 104 includes a transient voltage suppressor TSV1 for circuit protection and diodes D1, D2, D3 and D5 that form a rectifier bridge 104. The output of the bridge is fed to a voltage filtering circuit 106 at node 106. Circuit 106 includes diode D4, resistor R7, zener diode DZ1 clamped at 5.1 volts and capacitors C1, C2, C4 and C5. Circuit 106 produces a steady 5 volt output at node Vcc.

A controller or control circuit 110 is connected with power supply circuit 102 at node N2. Control circuit 110 is adapted to detect when the AC power supplied through connector 70 is on or is in a pulsing or flashing mode. Control circuit 110 includes an integrated circuit U1 that is a CY2413A clock/oscillator and capacitor C3.

Three white light emitting diodes LED1, LED2 and LED 3 are connected between node N3 and integrated circuit U3 through resistors R4, R5 and R6. Light emitting diodes LED1-LED3 only emit white light. Integrated circuit U3 is a DM414 light emitting diode driver and has 16 pins. Pins 9, 10 and 11 are connected to resistors R9, R10 and R11, respectively which are connected to ground.

A red, green, blue (RGB) light emitting diode LED4 is connected between node N4 and integrated circuit U2 through resistors R1, R2 and R3. Light emitting diode LED4 can selectively emit red, green or blue light. Light emitting diode LED4 includes three internal light emitting diodes labeled R, G and B for red, green and blue. Light emitting diode LED4 can also emit other colors including white by tuning on various combinations of the red, green or blue light emitting diodes. Integrated circuit U2 is a DM414 light emitting diode driver and has 16 pins. Pins 9, 10 and 11 are connected to resistors R12, R13 and R14, respectively which are connected to ground. Pins 14 and 15 of IC U3 are connected to pins 1 and 2 of IC U2.

A red, green, blue (RGB) light emitting diode LED5 is connected between node N5 and integrated circuit U4 through resistors R15, R16 and R17. Light emitting diode LED5 can selectively emit red, green or blue light. Light emitting diode LED5 includes three internal light emitting diodes labeled R, G and B for red, green and blue. Light emitting diode LED5 can also emit other colors including white by tuning on various combinations of the red, green or blue light emitting diodes. Integrated circuit U4 is a DM414 light emitting diode driver and has 16 pins. Pins 9, 10 and 11 are connected to resistors R18, R19 and R20, respectively which are connected to ground. Pins 14 and 15 of IC U2 are connected to pins 1 and 2 of IC U4.

A red, green, blue (RGB) light emitting diode LED6 is connected between node N6 and integrated circuit U5 through resistors R21, R22 and R23. Light emitting diode LED6 can selectively emit red, green or blue light. Light emitting diode LED6 includes three internal light emitting diodes labeled R, G and B for red, green and blue. Light emitting diode LED6 can also emit other colors including white by turning on various combinations of the red, green or blue light emitting diodes. Integrated circuit U5 is a DM414 light emitting diode driver and has 16 pins. Pins 9, 10 and 11 are connected to resistors R24, R25 and R26, respectively which are connected to ground. Pins 14 and 15 of IC U4 are connected to pins 1 and 2 of IC U5. Pins 14 and 15 of IC U5 are connected with pins 2 and 7 of IC U1 of control circuit 110.

Operation

Gaming device button 28 can be operated in a wide variety of operating states or modes. For example gaming device 28 may be operated in at least the following modes:

1. Off

2. White LEDs on

3. RGB LEDs on in one or more colors

4. White and RGB LEDs on

5. White LEDs blinking

6. RGB LEDs blinking in one or more colors

7. White and RGB LEDs blinking

Control circuit 110 detects the signals issued by controller 82 and operates the light emitting diodes in one of several modes to provide a button that can attract and entertain game players. Control circuit 110 can detect one or more control signals issued by controller 82. Control circuit 110 can decode the control signal and determine in which mode to operate the light emitting diodes.

Gaming device button 28 is in communication with controller 82 of gaming device 20. When gaming device 20 is idle, gaming device button 28 can be operated in an attract mode where only the colored red, green and blue light emitting diodes are operated. Control circuit 110 detects that controller 82 has generated an off or idle signal on wire harness 74 and operates the RGB LED's 4, 5 and 6. In this manner gaming device button 28 can attract game players to play gaming device 20.

After a game player has started to play gaming device 20, gaming device button 28 can be operated in a normal mode where only the white light emitting diodes LED's 1, 2 and 3 are operated. Control circuit 110 detects that controller 82 has generated an on signal on wire harness 74 and operates the white LED's.

When gaming device 20 enters a bonus mode activating bonus gaming device 30, gaming device button 28 can be operated in a bonus mode where the colored red, green and blue light emitting diodes are turned on and off in a blinking or flashing manner. Control circuit 110 detects that controller 82 has generated a flashing signal on wire harness 74 and operates the RGB LED's 4, 5 and 6 in a flashing or blinking manner by turning them on and off.

Gaming device button 28 can also be operated in a mode that is dependent upon the rate of the flashing signal received on wire harness 74. Control circuit 110 can detect the specified flashing rate and enter a pre-determined lighting mode.

When gaming device button 28 is depressed, switch 75 is closed. This allows a current to flow through switch 75. In this manner, button 28 performs as a switch circuit.

When switch 75 is closed, controller 82 may issue a signal to control circuit 110 to change the mode of operation of the light emitting diodes. Alternatively, when switch 75 is closed, the light emitting diodes may stay in the same operating mode.

Gaming device button 28 can be used or retrofitted to existing gaming devices. Gaming device button 28 can replace existing buttons on gaming or slot machines in order to present a more attractive gaming machine to game players. Gaming device button 28 is designed to plug into the existing wire harness and connector of a gaming apparatus. Gaming device button 28 works with the signals generated by the current controller that is designed into gaming device 20.

Although the description above contains many specifications, these should not be construed as limiting the scope of the invention but as merely providing illustrations of some of the presently embodiments of this invention. Thus, the scope of the invention should be determined by the claims as issued and their legal equivalents rather than by the examples given.

### CONCLUSION

Accordingly, the present invention provides a gaming device button that can be operated in multiple modes.

Although the description above contains many specifications, these should not be construed as limiting the scope of the invention but as merely providing illustrations of some of presently embodiments of this invention. Thus, the scope of the invention should be determined by the appended claims and their legal equivalents rather than by the examples given.

What is claimed is:

1. A button for a gaming device comprising:
(A) a housing, the housing being at least partially transparent, the housing adapted to be mounted to the gaming device, the housing having a cavity;
(B) at least one light emitting diode positioned in the cavity; and
(C) a control circuit in communication with the light emitting diode, the control circuit configured to control the operation of the light emitting diode.

2. The button of claim 1 wherein the light emitting diode comprises red, green and blue light emitting diodes.

3. The button of claim 1 wherein the control circuit is configured to cause the light emitting diode to change from a first mode to a second mode.

4. The button of claim 1 wherein the control circuit is configured to detect when the gaming device has changed from a first state to a second state.

5. The button of claim 1 wherein the light emitting diode is a white light emitting diode.

6. The button of claim 1 wherein a switch is mounted below the housing, the switch being adapted to be contacted by the housing when the button is depressed.

7. The button of claim 1 wherein the control circuit is mounted to a printed circuit board mounted in the cavity.

8. The button of claim 3 wherein the control circuit causes the light emitting diode to change from the first mode to the second mode when the gaming device changes from a first state to a second state.

9. A gaming device comprising:
(A) a button, the button comprising:
(a) a housing, the housing being at least partially transparent, the housing adapted to be mounted to the gaming device, the housing having a cavity;
(b) at least one light emitting diode positioned in the cavity; and
(c) a control circuit in communication with the light emitting diode, the control circuit configured to control the operation of the light emitting diode.

10. The gaming device of claim 9 wherein the light emitting diode further comprises red, green, blue and white light emitting diodes.

11. The gaming device of claim 9 wherein the control circuit causes the light emitting diode to operate in a plurality of modes.

12. The gaming device of claim 11 wherein the plurality of modes are chosen from the group consisting of:
a) all light emitting diodes off;
b) white light emitting diodes on;
c) red, green, blue light emitting diodes on in one or more colors;
d) white and red, green, blue light emitting diodes on;
e) white light emitting diodes blinking;
f) red, green, blue light emitting diodes blinking in one or more colors;
g) white and red, green, blue light emitting diodes blinking.

13. The gaming device of claim 9 wherein the control circuit and the light emitting diodes are mounted to a printed circuit board, the printed circuit board mounted in the cavity.

14. The gaming device of claim 9 wherein the button further includes a switch, the control circuit being adapted to detect closing of the switch.

15. The gaming device of claim 14 wherein the control circuit causes the light emitting diodes to change modes when the switch is closed.

16. A button for a gaming device comprising:
a) light emitting diode means for generating light; and
b) control means for controlling the operation of the light emitting diode means.
c) housing means for housing the light emitting diode means.

17. The button of claim 16 wherein the light emitting diode means comprises means for emitting red, green and blue light.

18. The button of claim 16 wherein the control means comprises means for causing the light emitting diode means to change from a first mode of operation to a second mode of operation.

19. The button of claim 16 wherein the control means comprises means for detecting when the gaming device has changed from a first state to a second state.

20. The button of claim 19 wherein the control means comprises means for causing the light emitting diode means to change from a first mode of operation to a second mode of operation in response to detecting when the gaming device has changed from a first state to a second state.

20. A method of operating a button for a gaming device comprising, not all necessarily in the order shown:
a) detecting a control signal;
b) decoding the control signal to determine a first operating mode for the light emitting diode; and
c) illuminating a light source in the button according to the first operating mode.

21. The method of claim 20 further comprising:
a) detecting a change in a game state of the gaming device from a first state to a second state; and
b) switching the operating mode of the light source from the first mode to a second mode.

22. The method of claim 20 illuminating the light source in a second mode.
